(19) United States
(12) Patent Application Publication
(10) Pub. No.: US 2003/0099461 A1
(43) Pub. Date: May 29, 2003

(54) Method and system for video recording compilation

(76) Inventor: Carolynn Rae Johnson, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 09/994,410

(22) Filed: Nov. 27, 2001

(51) Int. Cl. H04N 5/93; G11B 27/00

(52) U.S. Cl. 386/55; 386/52

(57) ABSTRACT

The invention concerns a method (200) and system (100) for generating a customized video recording compilation. The invention comprises the steps of: presenting (212) a menu which lists at least a portion of video segments recorded on a first storage medium; prompting (214) a user to select at least one video segment from the menu; compiling (218) each video segment selected by the user to create at least one compilation; and inserting (220) the compilation as a new item in the menu. The invention can also include the step of transferring (228) a video segment in the compilation from the first storage medium to a second storage medium. The invention can also include the step of automatically transferring (230) a plurality of video segments in the compilation from the first storage medium to a second storage medium without any user interaction following the initiation of the transferring step.

### BACKGROUND OF THE INVENTION

1. Technical Field

The inventive arrangements relate generally to video recording systems and more particularly to video recording systems that record video sequences onto storage media such as recordable digital video discs, hard drives and optical discs.

2. Description of Related Art

In today's marketplace, consumers can record multimedia data such as movies or television programs to a plethora of recordable storage media. Examples of such media include digital video discs (DVD) or hard disc drives (HDD). Due to technological advances, the storage capacity of these devices has increased tremendously over the past few years. As such, current recordable storage media can store a relatively large quantity of video, even though video generally requires a substantial amount of storage space. For example, some HDD's can store well over 300 hours of video.

Given the wide variety of programs that may be stored on these storage media, a consumer may wish to view only a limited number of preferred programs. For convenience, many recording media contain a menu that lists each of the programs that are currently stored on a particular medium. Once accessed, the consumer can select from the menu a desired program, and the storage medium device can playback the selection. Alternatively, the consumer can transfer, or copy, the selected program from its current storage medium to a secondary storage medium. Such a transfer process may be helpful if the consumer wishes to playback on a DVD player a video program that was originally recorded on a HDD or if the consumer wishes to create a backup recording of the program.

Unfortunately, there are several significant drawbacks to these current methods. For example, if a consumer wishes to view several programs consecutively, the consumer must access the menu and select a new program once the previous program is over. This access and selection step must be performed each time the consumer wants to watch another program. Further, if the consumer wants to record multiple programs from the current storage medium to the secondary medium, the consumer must initiate the recording step each time a new program is to be recorded. This technique is cumbersome as the user must be present to initiate each recording sequence. Thus, what is needed is a method and system for a video recording compilation that overcomes these limitations without increasing costs or system complexity.

### SUMMARY OF THE INVENTION

The present invention concerns a method of generating a customized video recording compilation. The method can comprise the steps of: presenting a menu which lists at least a portion of video segments recorded on a first storage medium; prompting a user to select at least one video segment from the menu; compiling each video segment selected by the user to create at least one compilation; and inserting the compilation as a new item in the menu. The method can also comprise the step of transferring a video segment in the compilation from the first storage medium to a second storage medium.

In one arrangement, the method can further comprise the steps of: prompting the user to place each selected video segment in an order; and placing the selected video segments in the order to reflect a customized viewing sequence. In another aspect, the invention can comprise the steps of: automatically transferring all video segments in the compilation from the first storage medium to a second storage medium with a single intervention from the user; prompting the user to create an identifier for the compilation; and designating the compilation with the identifier.

In another arrangement, the transferring step can further comprise the step of automatically transferring a plurality of video segments in the compilation from the first storage medium to a second storage medium without any user interaction following the initiation of the transferring step. In addition, the first storage medium can be selected from the group comprising an optical disc medium or a magneto disc medium. In another aspect, the second storage medium can be selected from the group comprising an optical disc medium, a magneto disc medium, a digital tape medium or an analog tape medium. As an example, the first storage medium can be a hard disc drive (HDD). Also, the prompting step can include the step of prompting a user to select at least two video segments from the menu.

The present invention also concerns a method of generating a customized video recording compilation including the steps of: displaying a list of menu items, wherein each menu item is associated with at least one portion of a plurality of video segments recorded on a storage medium; enabling the creation of a customized list of the menu items in a user selectable manner; and compiling each video segment from the customized list to create at least the customized video recording compilation as a new menu item on the list.

The present invention also concerns a system for generating a customized video recording compilation. The system includes: a menu which lists at least a portion of video segments recorded on a first storage medium; and a video processor programmed to: prompt a user to select at least one video segment from the menu; compile each video segment selected by the user to create at least one compilation; and insert the compilation as a new item in the menu. The system also includes suitable software and circuitry to implement the methods as described above.

### BRIEF DESCRIPTION OF THE DRAWINGS

FIG. 1 is a block diagram of a system that can generate a video recording compilation and can automatically transfer recordings from one storage medium to another in accordance with the inventive arrangements herein.

FIGS. 2(a) and 2(b), taken together, are a flow chart that illustrates an operation of generating a video recording compilation and automatically transferring recordings from one storage medium to another in accordance with the inventive arrangements.

FIG. 3 illustrates a screen shot of a menu containing a number of video segments stored on a storage medium in accordance with the inventive arrangements.

FIG. 4 illustrates a screen shot of a menu demonstrating a user selection process in accordance with the inventive arrangements.

FIG. 5 illustrates a screen shot demonstrating an order compilation option in accordance with the inventive arrangements.

FIG. 6 illustrates a screen shot demonstrating a name compilation option in accordance with the inventive arrangements.

FIG. 7 illustrates a menu containing a newly generated video compilation in accordance with the inventive arrangements.

### DETAILED DESCRIPTION OF THE PREFERRED EMBODIMENTS

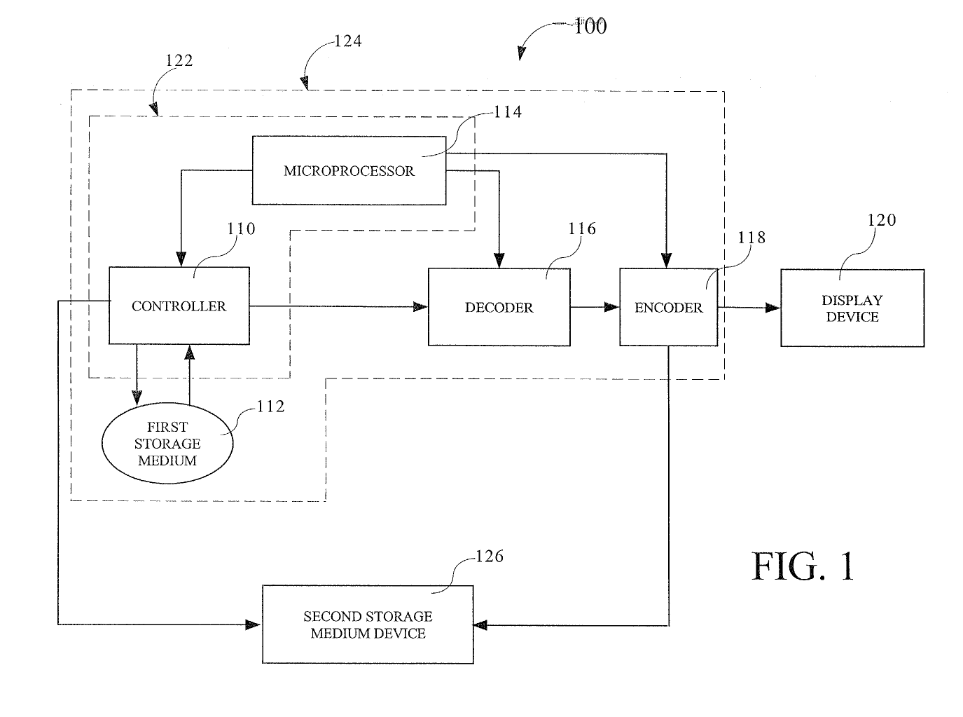

A system 100 for implementing the various advanced operating features in accordance with the inventive arrangements is shown in block diagram form in FIG. 1. The invention, however, is not limited to the particular system illustrated in FIG. 1, as the invention can be practiced with any other system capable of receiving a digitally encoded signal and transferring that signal to a display device. In addition, the system 100 is not limited to reading data from or writing data to any particular type of storage medium, as a wide variety of storage media, including media for storing digitally encoded data as well as analog data, can be used with the system 100.

The system 100 can include a controller 110 for reading data from and writing data to a first storage medium 112. The first storage medium 112 can include one or more menus for listing one or more video segments have been recorded on the first storage medium 112. The system 100 can also have a microprocessor 114, a decoder 116, an encoder 118 and a display device 120. In addition, it is understood that all or portions of the controller 110, the microprocessor 114 and in certain cases the encoder 118 can be a processor 122 within contemplation of the present invention. Similarly, all or portions of the controller 110, the first storage medium 112, the microprocessor 114, the decoder 116, and the encoder 118 can be a first storage medium device 124 within contemplation of the present invention. The system 100 can also include a second storage medium device 126.

Control and data interfaces can also be provided for permitting the microprocessor 116 to control the operation of the controller 112, the decoder 116 and the encoder 118. Suitable software or firmware can be provided in memory for the conventional operations performed by the microprocessor 114. Further, program routines can be provided for the microprocessor 114 in accordance with the inventive arrangements.

In operation, a user can access a menu from the first storage medium 112 through a user command received by the microprocessor 114. This menu can be displayed on the display device 120. The user can then select one or more video segments from the menu for purposes of generating a compilation. The microprocessor 114, in conjunction with the controller 110, can then insert the compilation into the menu.

In one arrangement, at least a portion of the compilation can be recorded from the first storage medium 112 to a second storage medium (not pictured) contained within the second storage medium device 126. If the second storage medium can receive a digitally encoded signal, the microprocessor 114 can instruct the controller 110 to transfer one or more video segments from the first storage medium 112 to the second storage medium in the second storage medium device 126. If the second storage medium is an analog storage medium, then the decoder 116 can decode and the encoder 118 can encode into an analog signal the video segments that are to be transferred to the second storage medium. The microprocessor 114 can then instruct the encoder 118 to transfer the encoded video segments to the second storage medium in the second storage medium device 126. If more than one video segment from the compilation is to be transferred, then this transfer can be accomplished with little user interaction. The overall operation of the invention will be discussed in greater detail below.

### Generating a Video Recording Compilation

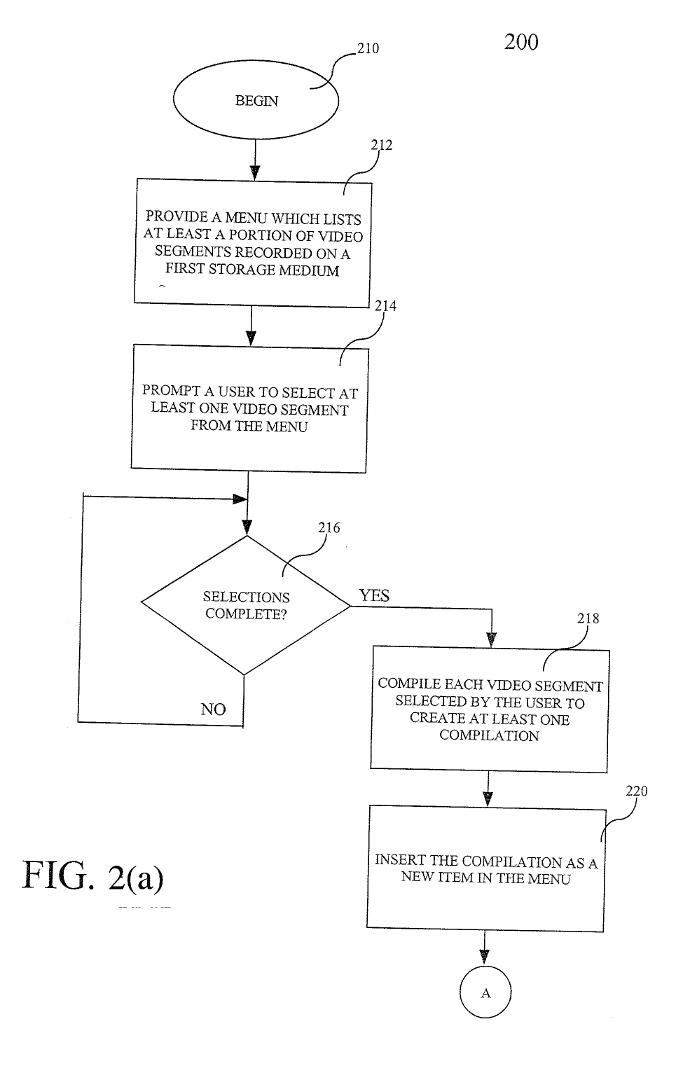

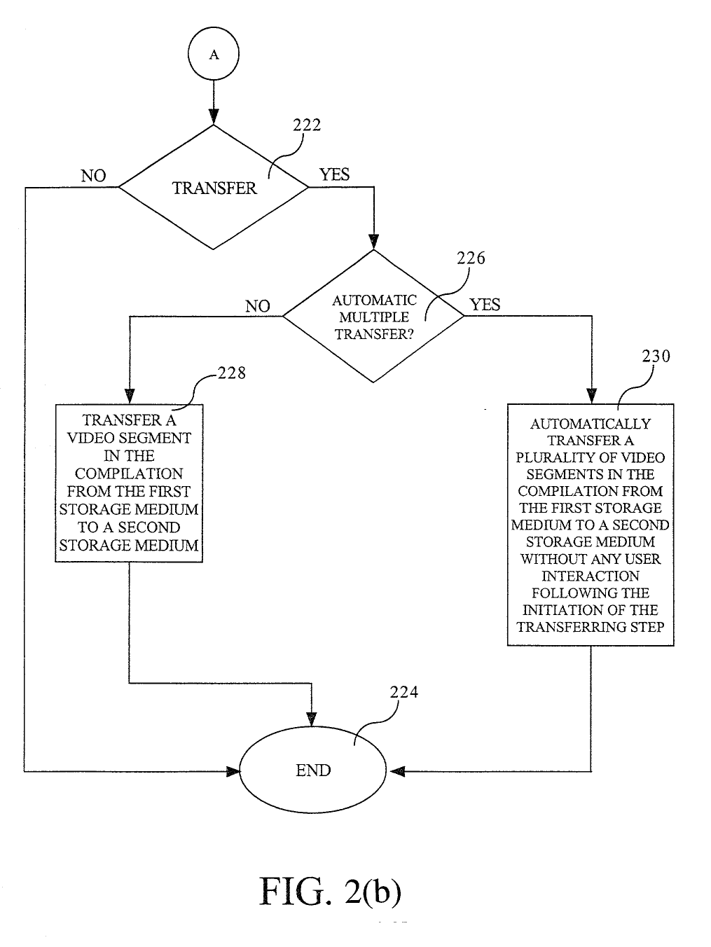

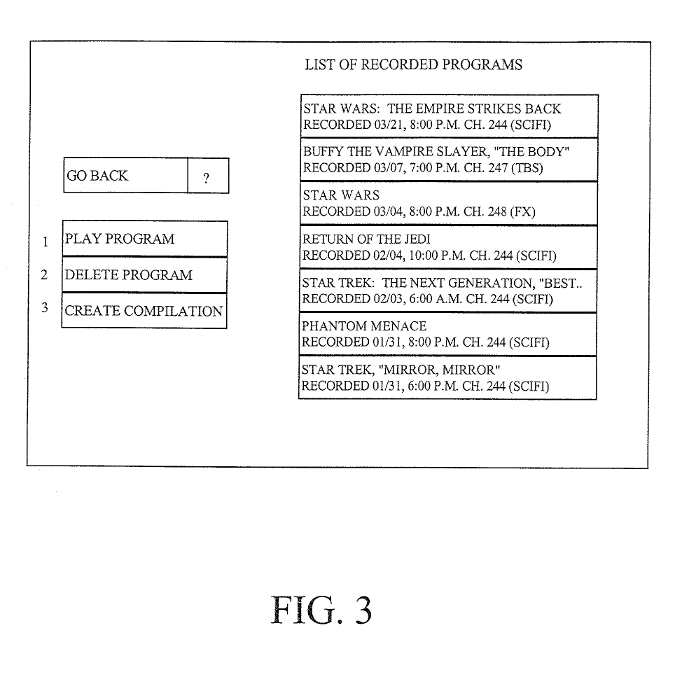

FIG. 2 illustrates a flowchart 200 that demonstrates one way in which a video recording compilation can be generated. At step 210, the process can begin. At step 212, a menu, which can list at least a portion of video segments recorded onto a first storage medium, can be provided. The term video segment can be any portion of previously recorded video and is not necessarily limited to an entire unit of programming such as a complete movie or television show. FIG. 3 illustrates an example of such a menu. As shown, the menu can list the name of the video segment, when it was created and the channel from which the segment was recorded. It is understood, however, that the menu of FIG. 3 is merely an example and that the menu can include other suitable types of information arranged in other suitable formats.

In one arrangement, the first storage medium, which can store the video segments listed in the menu, can be an optical disc medium, a magneto disc medium or any other suitable storage medium. As an example, the first storage medium can be a hard disc drive (HDD).

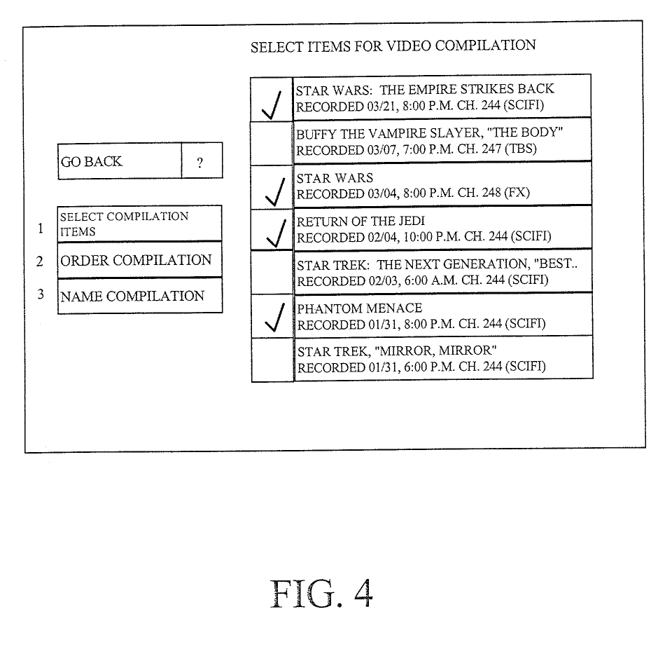

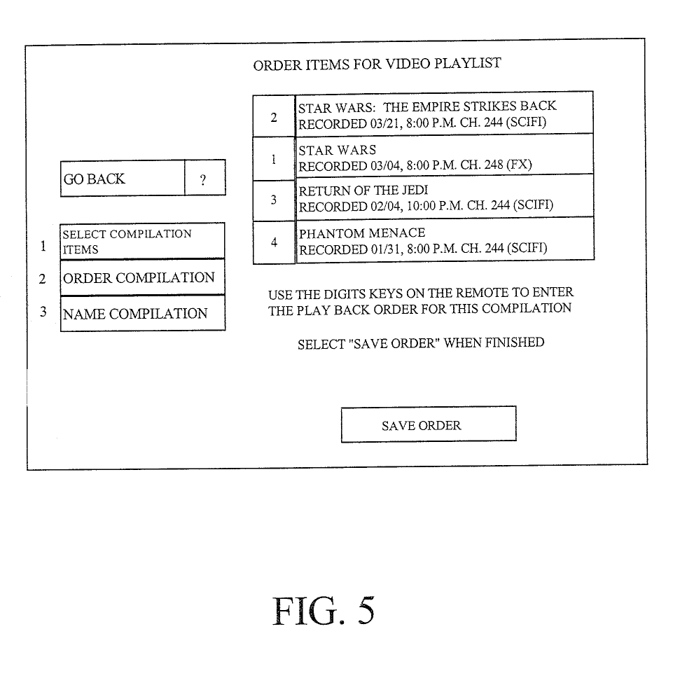

Referring back to FIG. 2, at step 214, a user can be prompted to select at least one video segment from the menu. As shown in FIG. 3, an example of this step is shown at option number 3 on the menu (the “create compilation” selection). FIG. 4 shows an example of a user selecting the desired video segments, which can be compiled to generate the video recording compilation. FIG. 4 also shows two other selectable options: (1) an “order compilation” option; and (2) a “name compilation” option. Once he or she has selected the desired video segments, the user can choose the order compilation option, and the user can be prompted to place the video segments (if more than one video segment is selected form the menu) in a desired viewing order. The video segments can then be placed in this order to reflect a customized viewing sequence. An example of this step is shown at FIG. 5. If the user does not select a particular viewing order, then the viewing segments can be placed in a random or default viewing sequence that could be based on any number of schemes including the chronological recording dates of each video segment selected, for example.

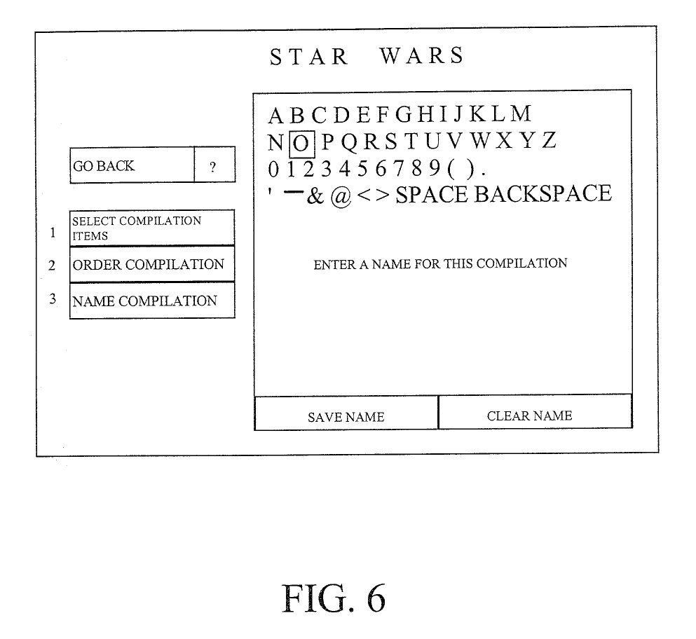

In another arrangement, the user can choose the name compilation option and can create an identifier for the compilation. Once the identifier has been created, the compilation can be designated with the identifier. An example of this identification process is shown at FIG. 6. Similar to the order compilation option, if the user does not create an identifier, then a default identifier can be created. It is understood that the invention is not limited to the examples illustrated in FIGS. 4-6, as other techniques for selecting, placing in a particular order and identifying one or more video segments can be employed. Moreover, it is important to note that the invention is not required to have the order compilation and name compilation options.

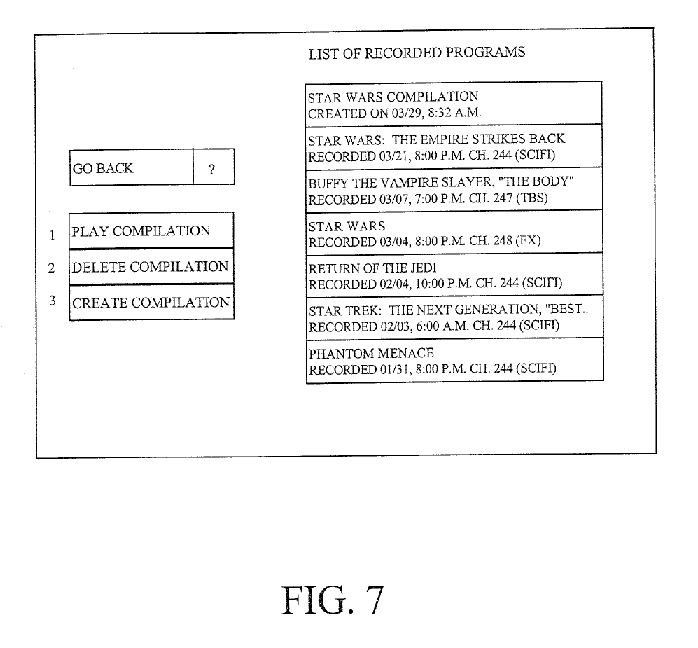

Referring once again to the flowchart 200, at decision block 216, if all the selections are complete, each video segment selected by the user can be compiled to create at least one compilation, as shown at step 218. At step 220, the compilation can be inserted in the menu as a new item. FIG. 7 shows an example of a menu in which the newly generated compilation has been inserted in the menu. Thus, the user can now access the newly generated customized video recording compilation for purposes of viewing a specific set of video segments. If the user wishes, these video segments can be placed in a preferred viewing order and can be easily located through the identifier. It should be noted that the “compilation” does not require the storage again or re-recording of each selected video segment within the first storage medium since each segment is already stored within the first storage medium, although the present invention is not limited thereto.

In another arrangement, one or more of the video segments that are in the compilation can be transferred from the first storage medium to a second storage medium. If a plurality of video segments in the compilation, or all the video segments in the compilation, are to be transferred, then the transferring step can be performed with a limited amount of user interaction. Specifically, at decision block 222 (through transfer node “A”), if a transfer of one or more video segments is to be performed, the flowchart 200 can proceed to decision block 226. If no transfer is to be made, then the flowchart 200 can end at step 224.

At decision block 226, if the user wishes to transfer only one video segment, then a video segment can be transferred from the first storage medium to a second storage medium, as shown at step 228. That is, the user can select one of the video segments from the newly created compilation and choose a “transfer option” (not pictured) to record the selected segment onto a different storage medium. Such a technique may be useful if the user wishes to make a backup copy of a video segment or if the user wishes to open up more space on the first storage medium. Similar to the first storage medium, the second storage medium can be an optical disc medium or a magneto disc. The second storage medium can also be a digital tape medium or an analog tape medium.

Referring back to decision block 226, if the user wishes to transfer multiple video segments, then the flowchart 200 can continue at step 230. As shown at step 230, a plurality of video segments in the compilation can be transferred from the first storage medium to the second storage medium without any user interaction following the initiation of the transferring step. For example, if the newly generated compilation contained five video segments and the user wants to transfer all five segments to a second storage medium, then the user can select a “transfer option” (similar to step 228), and each video segment can be automatically transferred to the second storage medium. Thus, once initiated, the user does not have to wait until the transfer of the first of the five video segments is completed to initiate the transfer of the second of the five video segments; the transfer of all selected video segments is automatically performed without any user interaction. Of course, the invention is not limited to the foregoing example, as any other suitable number of video segments can be transferred at step 230.

In another arrangement, the transfer of the one or more video segments can be programmed to occur at a later, more convenient time. Referring to the previous example, the user could select a “transfer later” option so that the five video segments that make up the compilation can be transferred at a pre-selected time. Such an option could enable the user to transfer large amounts of video automatically without interfering with other viewing habits.

Although the present invention has been described in conjunction with the embodiments disclosed herein, it should be understood that the foregoing description is intended to illustrate and not limit the scope of the invention as defined by the claims.

What is claimed is:

1. A method of generating a customized video recording compilation, comprising the steps of:
presenting a menu which lists at least a portion of video segments recorded on a first storage medium;
prompting a user to select at least one video segment from the menu;
compiling each video segment selected by the user to create at least one compilation; and
inserting the compilation as a new item in the menu.

2. The method according to claim 1, further comprising the step of transferring at least one video segment in the compilation from the first storage medium to a second storage medium.

3. The method according to claim 1, further comprising the steps of: prompting the user to place each selected video segment in an order; and placing the selected video segments in the order to reflect a customized viewing sequence.

4. The method of claim 1, further comprising the step of automatically transferring all video segments in the compilation from the first storage medium to a second storage medium with a single intervention from the user.

5. The method according to claim 1, further comprising the steps of: prompting the user to create an identifier for the compilation; and designating the compilation with the identifier.

6. The method according to claim 2, wherein said transferring step further comprises the step of automatically transferring a plurality of video segments in the compilation from the first storage medium to a second storage medium without any user interaction following the initiation of said transferring step.

7. The method according to claim 6, wherein the first storage medium can be selected from the group comprising an optical disc medium or a magneto disc medium.

8. The method according to claim 6, wherein the second storage medium can be selected from the group comprising an optical disc medium, a magneto disc medium, a digital tape medium or an analog tape medium.

9. The method according to claim 7, wherein the first storage medium is a hard disc drive (HDD).

10. The method according to claim 1, wherein the prompting step comprises the step of prompting a user to select at least two video segments from the menu.

11. A method of generating a customized video recording compilation, comprising the steps of:
displaying a list of menu items, wherein each menu item is associated with at least one portion of a plurality of video segments recorded on a storage medium;
enabling the creation of a customized list of the menu items in a user selectable manner; and
compiling each video segment from the customized list to create at least the customized video recording compilation as a new menu item on the list.

12. A system for generating a customized video recording compilation, comprising:
a menu which lists at least a portion of video segments recorded on a first storage medium; and
processor programmed to:
prompt a user to select at least one video segment from the menu;
compile each video segment selected by the user to create at least one compilation; and
insert the compilation as a new item in the menu.

13. The system according to claim 12, wherein the processor is further programmed to transfer a video segment in the compilation from the first storage medium to a second storage medium.

14. The system according to claim 12, wherein the processor is further programmed to:
prompt the user to place each selected video segment in an order; and
place the selected video segments in the order to reflect a customized viewing sequence.

15. The system according to claim 12, wherein the processor is further programmed to automatically transfer all video segments in the compilation from the first storage medium to a second storage medium with a single intervention from the user.

16. The system according to claim 12, wherein the processor is further programmed to:
prompt the user to create an identifier for the compilation; and
designate the compilation with the identifier.

17. The system according to claim 13, wherein the processor is further programmed to automatically transfer a plurality of video segments in the compilation from the first storage medium to a second storage medium without any user interaction following the initiation of the transferring step.

18. The system according to claim 17, wherein the first storage medium can be selected from the group comprising an optical disc medium or a magneto disc medium.

19. The system according to claim 17, wherein the second storage medium can be selected from the group comprising an optical disc medium, a magneto disc medium, a digital tape medium or an analog tape medium.

20. The system according to claim 18, wherein the first storage medium is a hard disc drive (HDD).

21. The system according to claim 12, wherein the processor is further programmed to prompt a user to select at least two video segments from the menu.

22. A system for generating a customized video recording compilation, comprising:
a menu for displaying a list of menu items, wherein each menu item is associated with at least one portion of a plurality of video segments recorded on a storage medium; and
a processor programmed to:
enable the creation of a customized list of the menu items in a user selectable manner; and
compile each video segment from the customized list to create at least the customized video recording compilation as a new menu item on the list
